(19) United States
(12) Patent Application Publication
(10) Pub. No.: US 2008/0060486 A1
(43) Pub. Date: Mar. 13, 2008

(54) LOCKING PLIERS FOR CONTROLLED MANIPULATION OF LOADS

(76) Inventor: THOMAS MICHAEL ROBERT, WILLIAMS, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/530,538

(22) Filed: Sep. 11, 2006

(51) Int. Cl. B25B 7/12

(52) U.S. Cl. 81/367

(57) ABSTRACT

Improved locking pliers are provided with a member having a threaded aperture welded, attached, or formed onto the handle of the pliers. The threaded aperture is adapted to receive a threaded rod or member for the application of pulling and pushing forces and other controlled movement or mobilization of the pliers. The axis of the threaded aperture is parallel to the axis of the adjustment knob of the pliers.

### BACKGROUND OF THE INVENTION

The present invention relates to locking pliers or wrenches. Specifically, the present invention relates to improved locking pliers or wrenches for the controlled manipulation of loads.

Various types of locking pliers are well known to those ordinarily skilled in the art and have been around for many years. Such locking pliers generally operate using an over-center toggle linkage that closes and locks a movable jaw in an adjustable position with respect to a fixed jaw. Once the toggle linkage or fulcrum bar has been closed to an over-center location, the opposing jaws of the locking pliers remain locked onto the object.

There are many instances when a user needs to use locking pliers to manipulate a load or to use the locking pliers as a third hand for holding a work piece. Prior art locking pliers used for manipulating loads generally have attachments affixed to the adjustment screw on the locking pliers such as those shown in U.S. Pat. No. 4,307,635 to Genova and Design Pat. No. D366,818 to McGarry. These designs do not allow for independent use of the locking pliers because the attachments are secured to the adjusting nut and do not allow the user to adjust the jaws for different size work pieces. Therefore, the user can only adjust the opening of the jaws if the attachments to the adjustment bolt can be manipulated.

Other prior art locking wrenches have attachments affixed to the locking pliers for manipulating the locking pliers such as U.S. Pat. No. 3,253,850 to Trusty; U.S. Design Pat. No. D260,476 to Knaus; and U.S. Pat. No. 5,460,461 to McGrath. One problem with these designs is that a user cannot properly use the handles of the locking pliers because of interference and location of the attached devices. Thus, the locking pliers of these designs have very limited use beyond their intended purpose. In other words, these locking pliers would be very difficult to use as standard locking pliers because of the placement of the attachments.

None of the aforementioned locking pliers' designs allows a user to use the locking pliers as standard locking pliers to manipulate a load in any direction without affecting either the adjustment bolt for the pliers or the use of the handle for squeezing and locking the pliers. Therefore, it is desirable to have locking pliers for the controlled manipulation of loads which remedies the aforementioned deficiencies.

The primary feature or advantage of the present invention is to provide an improved locking pliers for the precise manipulation of loads.

Another feature or advantage of the present invention is to provide a locking pliers which allow the users to manipulate a load by pulling, pushing, holding, elevating, suspension or other type of either general or precise manipulation of the load.

Another feature or advantage of the present invention is an improved locking pliers which improves the strength of the original locking pliers design.

Another feature or advantage of the present invention is an improved locking pliers which does not interfere with the normal locking or operation of the locking pliers.

Another feature or advantage of the present invention is an improved locking pliers which allow a user to indicate a weight limit for support using the locking pliers.

Another feature or advantage of the present invention is an improved locking pliers which allow the original equipment manufacturer to indicate if the equipment was original equipment on the pliers for attaching load manipulation devices to the pliers.

Another feature or advantage of the present invention is the potential tandem or lateral combining by a bar or otherwise supportive device of two or more locking pliers of the present invention which would allow the general or precise movement of larger or heavier loads.

A further feature or advantage of the present invention is a provision of a locking pliers for manipulating loads which is economical to manufacture, durable in use, and safe in operation.

One or more of these and/or other features or advantages of the present invention will be apparent from the specification and claims that follow.

### SUMMARY OF THE INVENTION

An improved locking pliers is provided with a member having a threaded aperture fixed on the handle of the locking pliers. In one embodiment, the member is in the form of a coupling nut or other extended wide nut welded to the handle. In another embodiment, the member is integrally formed as part of the handle during the manufacture of the pliers. In a third embodiment, the member is fixed to the handle using a band and a set screw. The threaded aperture or port is adapted to receive a threaded member, such as a hook, so that the pliers can be manipulated in any desired manner. For example, the threaded aperture allows controlled pulling, pushing or elevation forces to be applied to the pliers. Preferably, the aperture has a longitudinal axis which is parallel to the axis of the adjustment screw or knob of the pliers. The threaded member also allows the pliers to be suspended or hung while a piece is gripped by the pliers. The member does not interfere with the normal locking operation or any other normal operation of the pliers.

### BRIEF DESCRIPTION OF THE DRAWINGS

FIG. 1 is a perspective view of the improved locking pliers of the present invention.

FIG. 2 is a side elevation view of the improved locking pliers shown in FIG. 1.

FIG. 3 is a perspective view of an alternative embodiment of the improved locking pliers of the present invention.

FIG. 4 is a plan view of a blank used in forming the handle of the locking pliers shown in FIG. 3.

FIG. 5 is a side elevation view of another embodiment of the improved locking pliers of the present invention.

FIG. 6 is a side elevation view showing the locking pliers gripped to an overhead beam with a load applied via the member, in accordance with the present invention.

FIG. 7 is an enlarged view taken along lines 7-7 of FIG. 1.

FIG. 8 is a view showing an indicia for an original equipment manufacturer of the improved locking pliers.

FIG. 9 is a view showing tandem or lateral connection of four pliers equipped with the present invention and connected to a wide load.

FIG. 10 is a view showing a pair of pliers according to the present invention used in tandem to hold a load.

### DETAILED DESCRIPTION OF THE DRAWINGS

The locking pliers of the present invention are generally designated by the reference numeral 10 in the drawings. The pliers 10 include a handle member 12 with a fixed jaw 14 at the forward end and a threaded sleeve 16 at the rearward end. The handle 12 is generally formed from a flat blank or plate which is bent into a U shape having opposite side walls 18. The sleeve 16 is formed by opposite edges of the plate being wrapped around to meet at a seam 17. A pivot pin 20 extends between the side walls 18 of the handle 12. The fixed jaw 14 is welded to the enlarged wings or flanges 22 of the handle 12 after the handle is formed.

A moveable jaw 24 is pivotally connected to the handle 12 by the pin 20. A lever 28 is pivotally connected to the moveable jaw 24 via a pivot pin 26. The lever 28 has a U-shaped construction with opposite side walls 32 between which the moveable jaw 24 extends. A fulcrum bar 34 extends between the opposite sides 32 of the lever 28 and is pivotally connected thereto by a pin 30. The opposite end of the fulcrum bar 34 is received between the side walls 18 of the handle 12 adjacent the rearward end thereof, so as to be in contact with a threaded shank 36 matingly received in the threaded sleeve 16. The shank 36 has a knurled end or knob 37 for turning the shank 36 into or out of the sleeve 16 so that the rearward end of the fulcrum bar 34 slides within the channel formed by the opposite side walls 18 of the handle 14.

A spring 38 is connected to the moveable jaw 24 at a spring anchor point 40 and at the opposite end to the interior of the handle 12. The spring 38 biases the moveable jaw 24 to an open position.

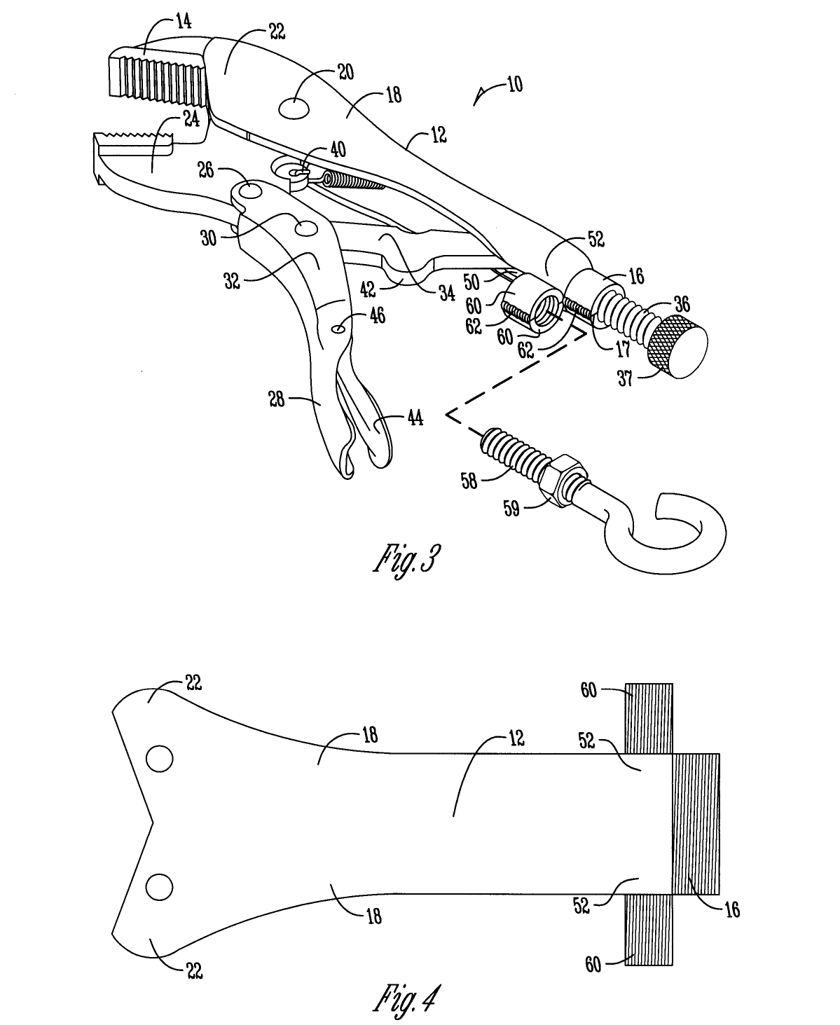

The fulcrum bar 34 has an intermediate lobe or lug 42 which engages the lever 28 when the pliers 10 is closed, as seen in FIG. 2. A release lever 44 is pivotally connected to the lever 28 by a pin 46. When the rearward end of the release lever 44 is squeezed toward the rearward end of the lever 28, the release lever 44 pivots about the pin 46 so that the forward end 48 of the release lever 44 pushes against the lobe 42 of the fulcrum 34 so as to release the pliers 10 from a gripping mode.

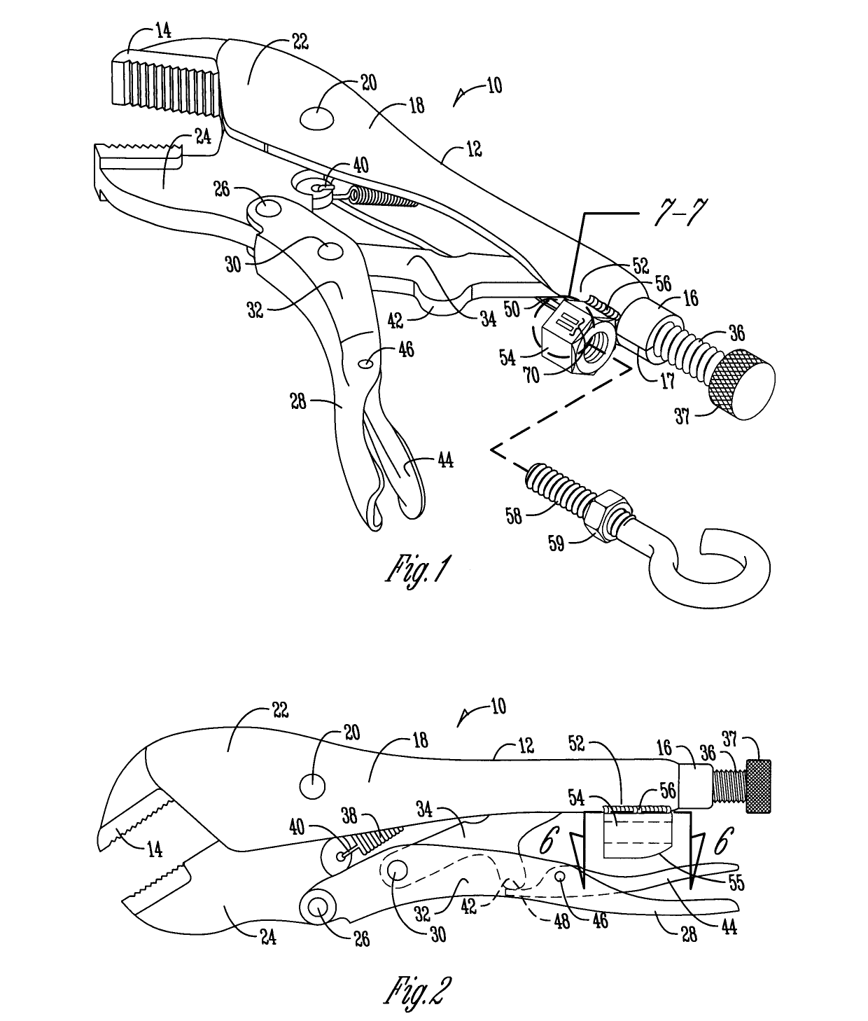

The above-described structure of the pliers 10 is conventional. The locking pliers 10 are improved in the present invention by the addition of a member 54 having threaded port or aperture on the rearward end of the handle 12. As seen in the preferred embodiment of FIG. 1, the member 54 is in the form of a coupling nut or other extended wide nut welded on opposite sides to the rear flanges 52 of the handle 12 so as to overlay the longitudinal slot 50 extending between the handle flanges 52. Thus, the axis of the member 54 is substantially parallel to the axis of the sleeve 16. It is understood that the aperture 54 could also be formed by welding the coupling nut or other extended wide nut at any location around the rearward end of the handle 12 in an orientation parallel to the sleeve 16. It is noted that with the coupling or extended wide nut 54 welded to the inside of the handle 12, as shown in FIGS. 1 and 2, the axis of the aperture passes through the fixed jaw 14. Preferably, a weld 56 is provided on each side of the coupling or wide nut 54 and each side wall 18 of the handle 12, which precludes the sleeve 16 from being opened along the seam 17.

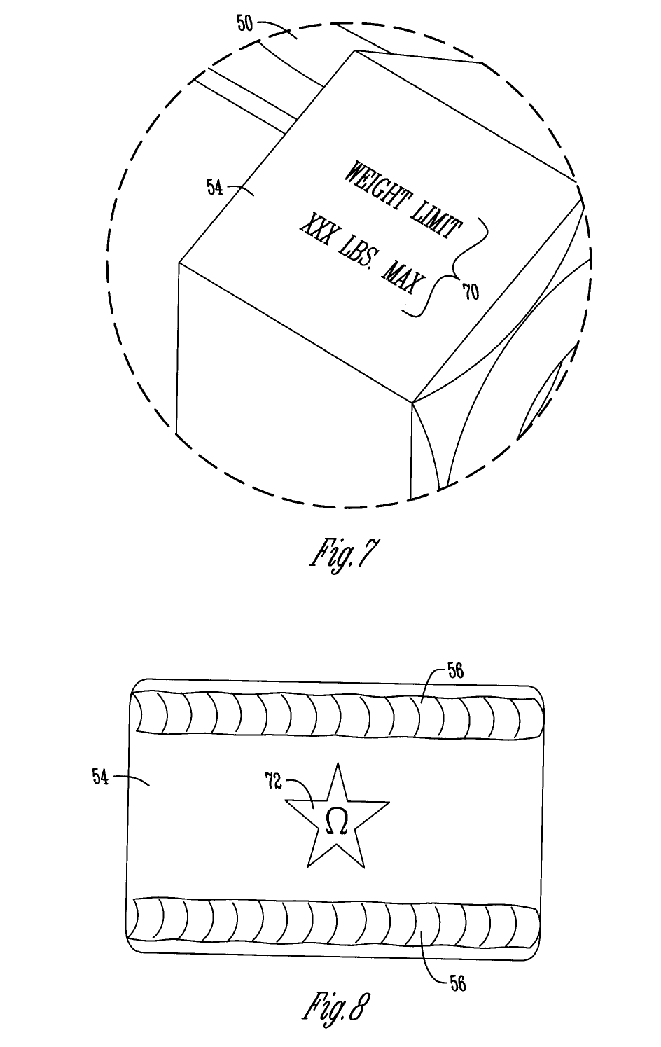

A threaded attachment rod 58 can be matably threaded into the coupling or extended wide nut 54. FIG. 1 shows the rod 58 to be in the form of a hook, although other forms may also be utilized which allow both pulling and pushing forces to be applied to the pliers 10 through the threaded connection of the rod 58 and the nut 54. As seen in FIG. 6, the nut 54 and the rod 58 do not interfere with the operation of the fulcrum bar 34 or the release lever 44. Thus, the pliers 10 are fully functional. If necessary, the rearward end of the member 54 may be tapered or beveled so as to have a reduced diameter to assure that interference is avoided. The rod 58 is provided with a lock or jam nut 59 to tighten against nut 54 once the desired position of the pliers 10 is set, so as to lock the pliers in the exact position.

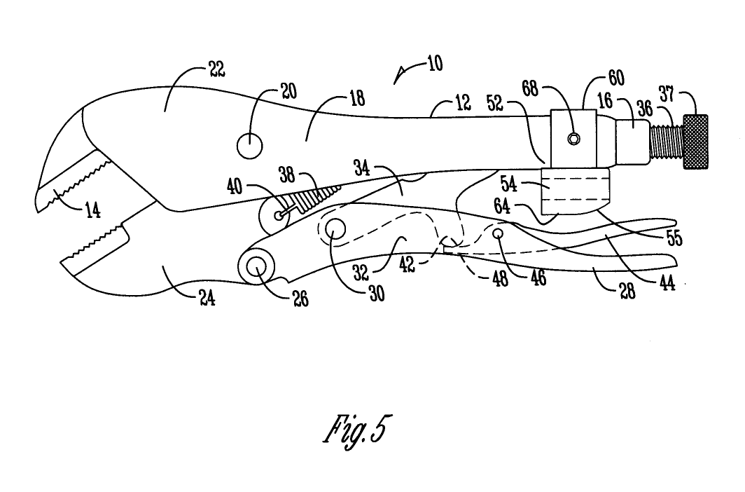

A second embodiment of the improved pliers 10 of the present invention is shown in FIGS. 3 and 4. In this alternative embodiment, the nut 54 is replaced with a member formed by a pair of lobes 60 on the handle blank, such that the member is integral with the handle 12 when the handle is manufactured. A weld 56 may be applied along the seam of the lobes 60 and along the seam 17 of the sleeve 16 so as to preclude spreading or pulling apart of the lobes 60 or the sleeve 16. The internal threads of the member lobes 60 are adapted to receive the threaded rod 58, as described with respect to the first embodiment of FIGS. 1 and 2.

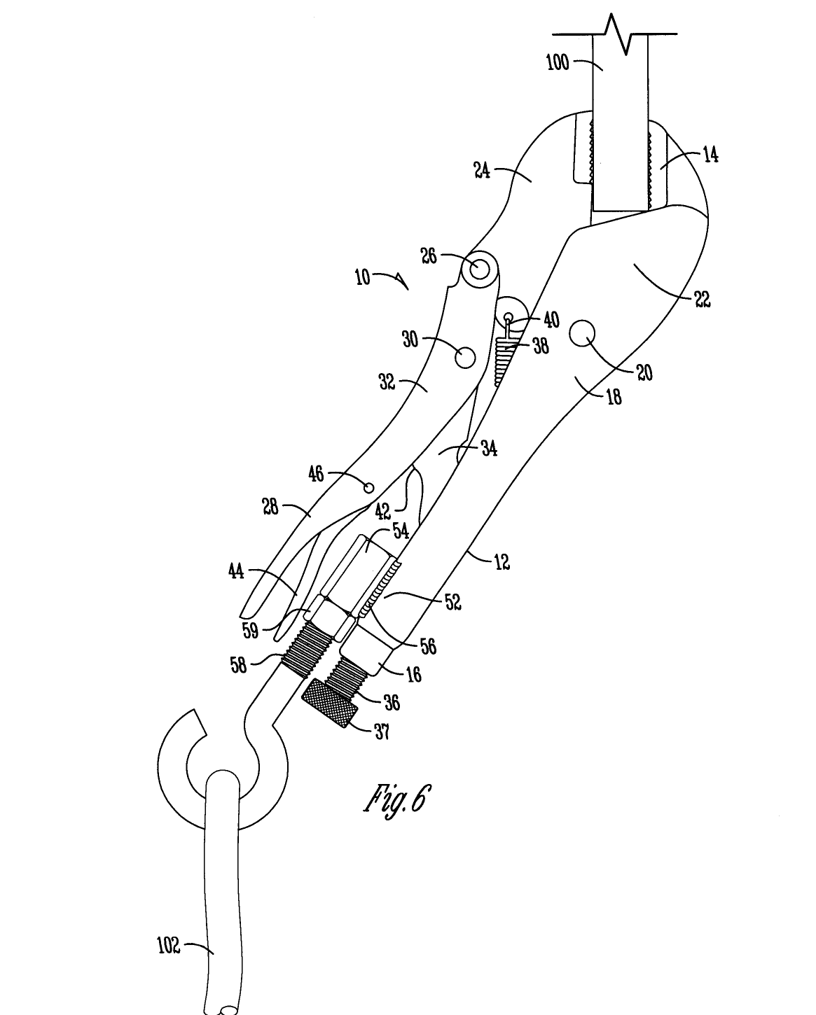

FIG. 5 shows a third embodiment of the present invention, wherein the member is a threaded collar 64 retrofit onto the handle 12 by a band 66 slid over the sleeve 16 and onto the handle 12, and secured thereto by a set screw 68. The internal threads of the collar 64 are adapted to receive the rod 58, as described above with respect to the embodiment of FIGS. 1 and 2.

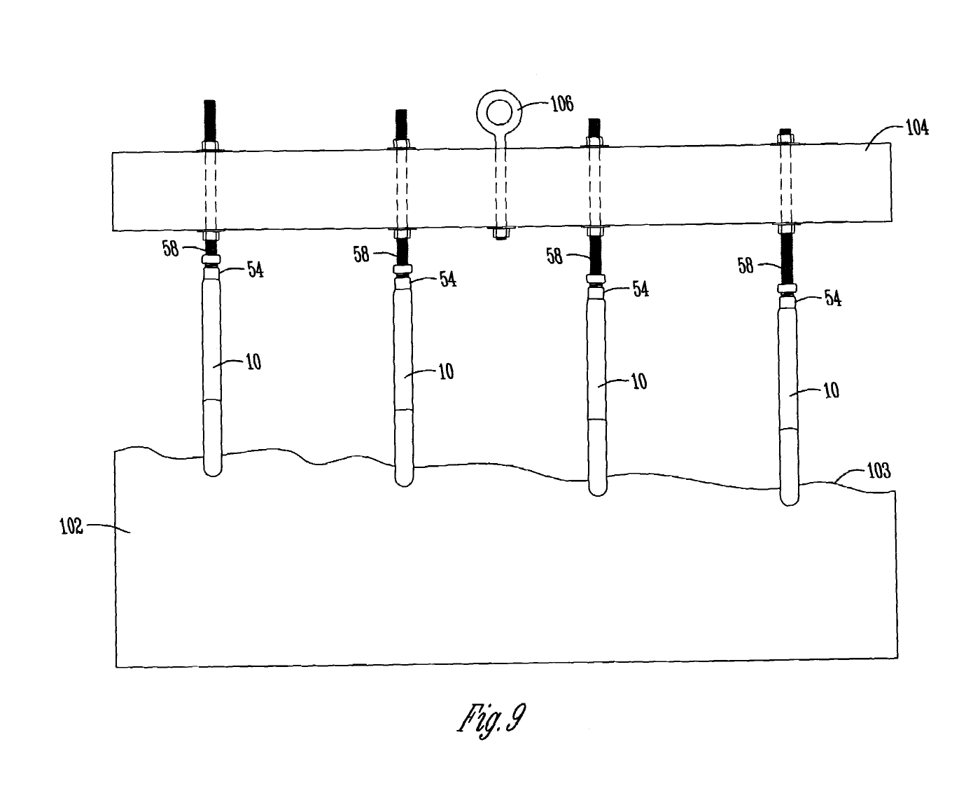

As seen in FIG. 7, the nut 54, lobes 60 or collar 64 which form the apertured member may include text 62 regarding the weight limit for the pliers 10. Alternatively or additionally, the member 54 may also include a name or indicia 64, as seen in FIG. 8, to identify a manufacturer for product liability purposes.

In use, the pliers 10 allow a pulling, pushing, twisting, or other force to be applied to the pliers 10 via the rod 58 threaded into the nut 54, lobe 60, or collar 64. Similarly, a pushing force can be applied through the axis of the nut 54, lobe 60, or collar 64 and a threaded member or rod 58. As a further alternative, the locking pliers 10 can be locked onto a support, such as a beam 100, with a load 102 suspended from the opposite end of the rod 58, as seen in FIG. 6.

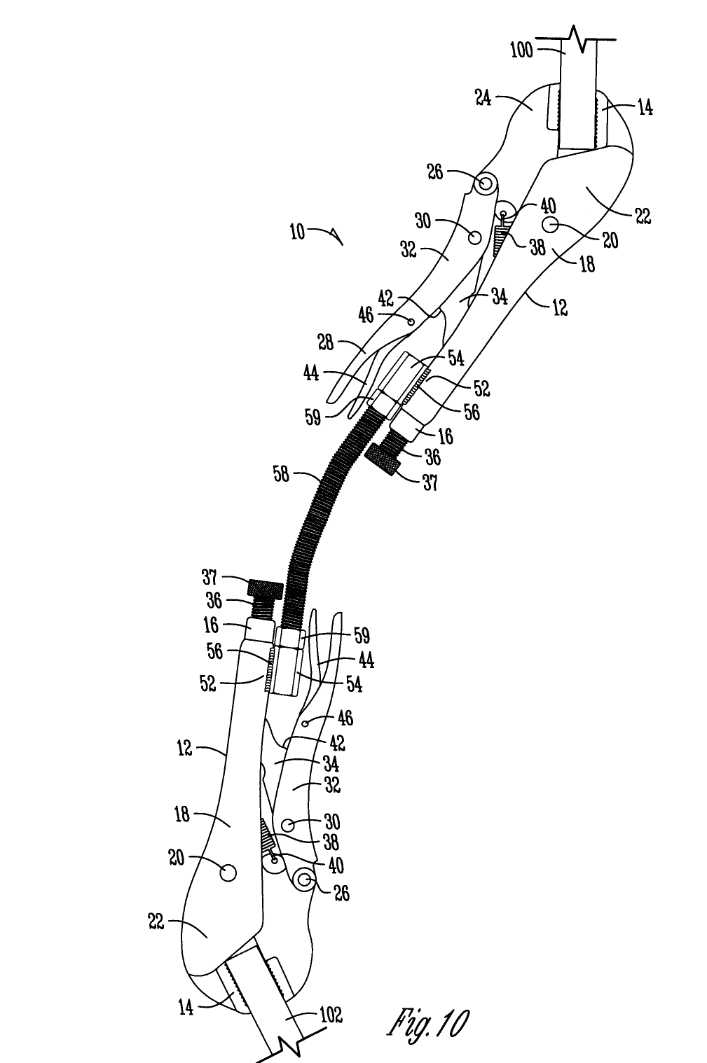

FIG. 9 shows multiple pliers 10 used to support a large work piece 102. The rod 58 is connected to the pliers 10 have different lengths to accommodate an uneven edge 103 of the piece 102. The rods 58 are bolted or attached to a bar or support beam 104 so that the piece 102 can be pulled, pushed or suspended to a desired position. While four pliers 10 are shown, it is understood that any number of pliers 10 can be utilized in combination, depending on the size and weight of the load 102. An eye-bolt 106 may be provided on the beam 104 to lift the piece 102 via the pliers 10.

FIG. 10 shows a pair of pliers 10 according to the present invention which are interconnected by a rod 58, with one of the pliers clamped to a support beam 100 and the other pliers 10 gripping a load or work piece 102.

Thus, the threaded aperture connected to the handle 12 of the locking pliers 10, in the form of the nut 54, the lobe 60, or the collar 64, increases the versatility and applications for the locking pliers 10, including controlled movement, pulling, pushing, twisting, lifting and/or suspension of the pliers.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

1. A locking pliers assembly comprising:
a handle having a longitudinal axis;
a first jaw coupled with the handle;
a second jaw moveably opposing the first jaw;
a locking lever coupled with the second jaw;
a release lever positioned between the handle and the locking lever and pivotally connected to the locking lever;
a bar coupled between the handle and the locking lever for locking the first and second jaws in a closed position;
a member rigidly attached to the handle and being adapted to couple an attachment to the handle without interfering with movement of the locking pliers, for applying pulling and pushing forces to the handle; and
the member having an aperture adjacent the handle with a longitudinal axis parallel to the handle axis, and the handle and aperture axes being non-concentric.

2. The locking pliers assembly of claim 1 wherein the handle member further comprises a pair of handle flanges spaced apart whereby the member is welded to each handle flange of the handle.

3. The locking pliers assembly of claim 2 wherein the member is marked with an indicator to indicate that the member is original equipment to the pliers assembly.

4. The locking pliers assembly of claim 1 wherein the member is a threaded nut adapted to couple the attachment to the locking pliers on a longitudinal plane passing through the jaws to thereby balance forces on each jaw.

5. The locking pliers assembly of claim 1 wherein flanges of the handle each has a lobe to thereby form the member.

6. The locking pliers assembly of claim 1 wherein the member is a threaded collar having a band extending around the handle adapted to couple the attachment to the locking pliers on a longitudinal plane passing through the jaws to thereby balance forces on each jaw.

7. The locking pliers assembly of claim 1 wherein the member is marked with a load limit.

8. The locking pliers assembly of claim 7 wherein the member has a reduced diameter portion between the handle and the release lever to avoid interference of operation of the release lever.

9. An improved locking pliers tool having a handle with a first jaw coupled to the handle having a longitudinal axis, a second jaw moveably opposing the first jaw, a locking lever coupled with the second jaw, and a bar extending between the handle and the locking lever for controlling locking and unlocking of the jaws, and a release lever positioned between the handle and the locking lever and pivotally connected to the locking lever for unlocking the jaws, the improvement comprising:
a member on the handle for receiving a load manipulating attachments adjacent the handle, the member having a longitudinal axis parallel to and offset from the handle axis such that the member is positioned to thereby avoid interference with movement of the levers.

10. The tool of claim 9 wherein the handle further comprises a pair of handle flanges spaced apart whereby the member is welded to each handle flange of the handle.

11. The tool of claim 9 wherein the member is marked with an indicator to indicate that the member is original equipment to the tool.

12. The tool of claim 9 wherein the member is a nut adapted to couple the load manipulating attachment to the locking pliers on a longitudinal plane passing through the jaws to thereby balance forces on each jaw.

13. The tool of claim 9 wherein flanges of the handle member each has a lobe to form the member to thereby strengthen both the member and the handle against spreading apart under force from the load manipulating attachment.

14. The tool of claim 9 wherein the member is marked with a load limit.

15. (canceled)

16. The tool of claim 9 wherein the member is formed with a reduced portion between the handle and the release lever to avoid interference of operation of the release lever.

17. A locking wrench comprising:
a handle having first and second opposite ends and having flanges spaced apart to thereby form a channel;
a first jaw fixed to the first end of the handle;
a second jaw pivotally attached to the handle and moveably opposing the first jaw;
an elongated locking lever pivotally connected to the moveable jaw and moveable toward and away from the handle;
an adjusting shank threadably received in a sleeve of the second end of the handle for adjusting a closing dimension of the first and second jaws;
a fulcrum bar pivotally connected to the lever and slideable in the channel of the handle for locking the first and second jaws in a closed position when the locking lever is squeezed toward the handle;
a biasing spring between the second jaw and the handle for exerting pull on the second jaw and to maintain the fulcrum bar in contact with the adjusting shank; and
a member rigidly attached across the channel to each flange, the member positioned for receiving load manipulating attachment the inside of the handle between the locking lever and the handle and for strengthening the channel by preventing spreading apart of the channel.

18. (canceled)

19. The locking wrench of claim 17 wherein the first and second flanges of the handle member each have a lobe to thereby form the member and strengthen both the member and the handle against spreading apart under force from load manipulating attachments.

20. The locking wrench of claim 17 wherein the member is threaded and adapted to couple load manipulating attachments to the locking wrench on a longitudinal plane passing through the jaws to thereby balance forces on each jaw when pulling, pushing or holding onto an object held between the jaws.

21. The locking wrench of claim 17 wherein the handle and member have parallel offset longitudinal axes.
